(19) United States
(12) Patent Application Publication
(10) Pub. No.: US 2008/0011027 A1
(43) Pub. Date: Jan. 17, 2008

(54) Padlock

(76) Inventor: Chun Te Yu, Fusing Township (TW)

Correspondence Address: HDSL, 4331 STEVENS BATTLE LANE, FAIRFAX, VA, 22033, US

(21) Appl. No.: 11/781,238

(22) Filed: Jul. 21, 2007

Related U.S. Application Data
(63) Continuation-in-part of application No. 10/833,076, filed on Apr. 28, 2004, now Pat. No. 7,251,965.
(63) Continuation-in-part of application No. 11/603,029, filed on Nov. 22, 2006.

(51) Int. Cl. E05B 67/06

(52) U.S. Cl. 70/24

(57) ABSTRACT

A padlock includes a lock body, a shackle and at least one locking unit. The lock body includes a first lock hole defined therein and a second lock hole defined therein. The shackle includes a first end for insertion in the first lock hole and a second end for insertion in the second lock hole. In the lock body, the locking unit is changeable between a locking position for locking the first and second ends of the shackle in the first and second lock holes, a first unlocking position for allowing the first end of the shackle to be removed from the first lock hole and a second unlocking position for allowing the second end of the shackle to be removed from the second lock hole.

### CROSS-REFERENCE

The present patent application is a continuation-in-part application of U.S. patent application Ser. No. 10/833,076, filed on Apr. 28, 2004 and Ser. No. 11/603,029, filed on Nov. 22, 2006, of which the entire disclosures are incorporated herein.

### BACKGROUND OF INVENTION

1. Field of Invention

The present invention is related to a padlock and, more particularly, to a padlock with double locking effects.

2. Related Prior Art

Padlocks include combination (or “numeral”) padlocks and key-operable padlocks. The combination padlocks include a numeral-wheel type and a button type. These padlocks are used in various fields. For example, Taiwanese Patent Nos. 369068 and 498918 disclose key-operable padlocks. Taiwanese Patent Nos. 32470 and 46563 disclose combination padlocks.

Deeming a trunk, a suitcase, a briefcase, a bag or the like suspicious, U.S. customs workers are authorized to break its lock or locks for security check. Such a damaged lock is a loss of a user and causes the user trouble and inconvenience.

To avoid the above-mentioned problems, the U.S. government regulates that lock manufacturers must provide the U.S. customs with a standard key for opening their locks. According to this regulation, several lock manufacturers all over the world are allowed to manufacture such locks.

It is therefore intended to provide a locking apparatus which meets the regulation of the U.S. government. Furthermore, in case a user forgets to bring his key or forgets an unlocking number, the locking apparatus provides the user with another measure for unlocking it.

The present invention is therefore intended to obviate or at least alleviate the problems encountered in prior art.

### SUMMARY OF INVENTION

It is therefore the primary objective of the present invention to provide a padlock with double effects.

To achieve the primary objective of the present invention, there is provided a padlock including a lock body, a shackle and at least one locking unit. The lock body includes a first lock hole defined therein and a second lock hole defined therein. The shackle includes a first end for insertion in the first lock hole and a second end for insertion in the second lock hole. In the lock body, the locking unit is changeable between a locking position for locking the first and second ends of the shackle in the first and second lock holes, a first unlocking position for allowing the first end of the shackle to be removed from the first lock hole and a second unlocking position for allowing the second end of the shackle to be removed from the second lock hole.

The present invention can be best understood through the following description and accompanying drawings wherein:

Other objectives, advantages and features of the present invention will become apparent from the following description referring to the attached drawings.

### BRIEF DESCRIPTION OF DRAWINGS

The present invention will be described by the detailed illustration of three embodiments referring to the drawings wherein:

FIG. 1 is a perspective view of a padlock according to the first embodiment of the present invention;

FIG. 2 is a top view of the padlock;

FIG. 3 is a front view of the padlock in another position than shown in FIG. 1;

FIG. 4 is a front view of the padlock in another position than shown in FIG. 3;

FIG. 5 is a perspective view of a padlock according to the second embodiment of the present invention;

FIG. 6 is a front view of the padlock in another position than shown in FIG. 5;

FIG. 7 is a front view of the padlock in another position than shown in FIG. 6;

FIG. 8 is a perspective view of a padlock according to the third embodiment of the present invention;

FIG. 9 is a front view of the padlock in another position than shown in FIG. 8;

FIG. 10 is a front view of the padlock in another position than shown in FIG. 9;

FIG. 11 is a perspective view of a first key, a second key and a locking unit of the padlock shown in FIG. 10; and

FIG. 12 is an exploded view of the locking unit shown in FIG. 11.

### DETAILED DESCRIPTION OF EMBODIMENTS

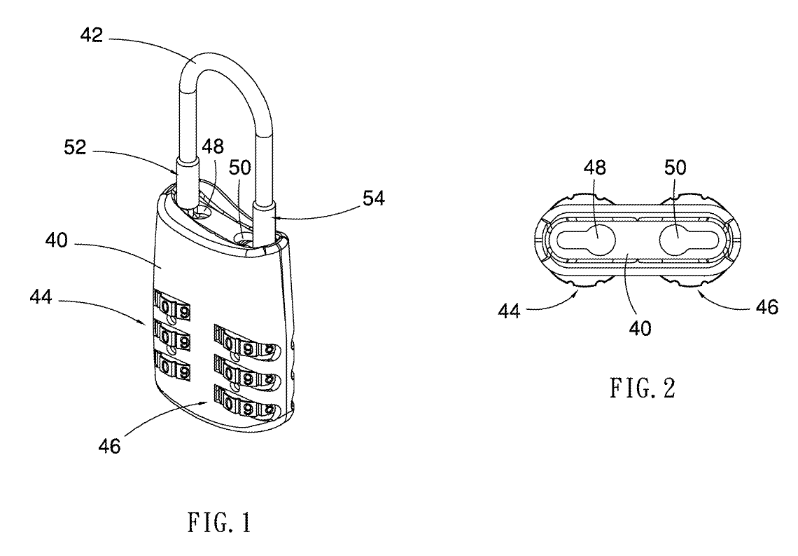

Referring to FIGS. 1 through 4, according to a first embodiment of the present invention, a padlock includes a lock body 40, a shackle 42, a first combination locking unit 44 for locking a first end of the shackle 42 in the lock body 40 and a second combination locking unit 46 for locking a second end of the shackle 42 in the lock body 40. The padlock of is 11 similar to those shown in U.S. patent application Ser. No. 10/833,076 except including two combination locking units 44, 46 instead of a combination locking unit and a key-operable locking unit.

The lock body 40 is similar to the lock body shown and described in U.S. patent application Ser. No. 10/833,076. The lock body 40 includes first and second lock holes 48 and 50 defined therein as shown in FIG. 2. More details of the lock body 40 will not be provided for briefness.

The shackle 42 is similar to the shackle shown and described in U.S. patent application Ser. No. 10/833,076. The shackle 42 includes a first insert 52 secured to the first end thereof and a second insert 54 secured to the second end thereof. The first insert 52 includes a neck 56 and a head 58. The second insert 54 is structurally similar to the first insert 52 and includes a neck 60 and a head 62. More details of the shackle 42 will not be given for briefness.

The first and second combination locking units 44 and 46 are structurally similar to the combination locking unit shown in U.S. patent application Ser. No. 10/833,076. The first and second combination locking units 44 and 46 are disposed in the lock body 40. The first combination locking unit 44 can be switched between a locking position and an unlocking position. The second combination locking unit 46 can be switched between a locking and an unlocking position regardless of the first combination locking unit 44. More details of the first and second combination locking units 44 and 46 will not be given for briefness.

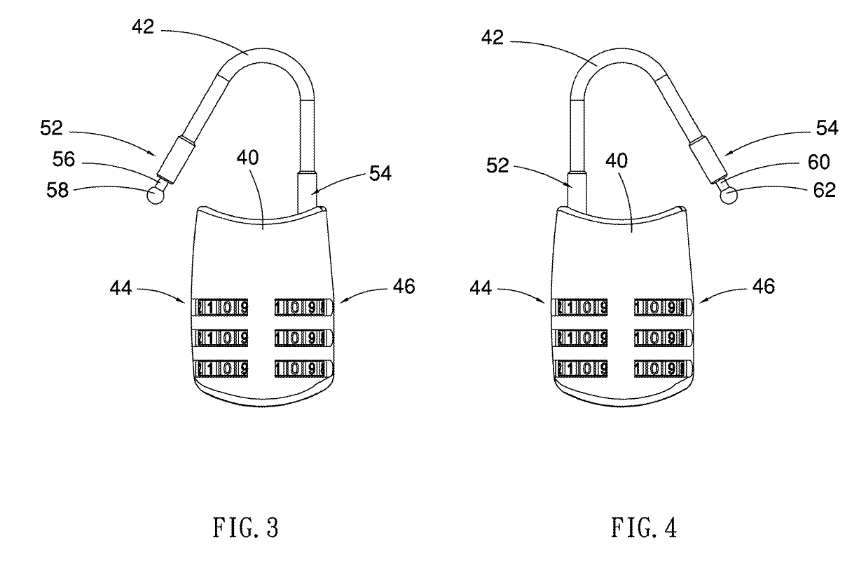

Referring to FIG. 3, when turned to a first unlocking number, the first combination locking unit 44 is switched to the unlocking position from the locking position. Thus, the first insert 52 can be removed from the first lock hole 48. Therefore, the shackle 42 is unlocked.

Referring to FIG. 4, when turned to a second unlocking number, the second combination locking unit 46 is switched to the unlocking position from the locking position. Thus, the second insert 54 can be removed from the second lock hole 50. Therefore, the shackle 42 is unlocked.

The first unlocking number can be determined and known only by a user of the padlock. The second unlocking number can be determined only by a manufacturer of the padlock and known by customs workers as well as the manufacturer.

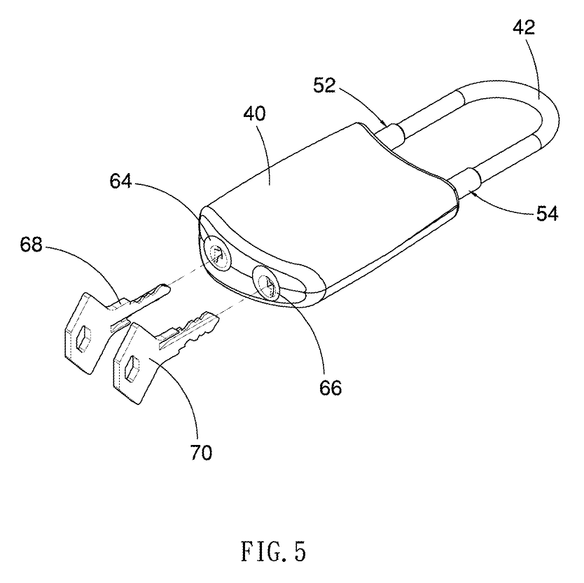

Referring to FIGS. 5 through 7, there is shown a padlock according to a second embodiment of the present invention. The second embodiment is similar to the first embodiment except including a first key-operable locking unit 64 and a second key-operable locking unit 66 instead of the first combination locking unit 44 and the second combination locking unit 46, respectively. The first and second key-operable locking units 64 and 66 are structurally similar to the key-operable locking unit shown in U.S. patent application Ser. No. 10/833,076. The first and second key-operable locking units 64 and 66 are disposed in the lock body 40. The first key-operable locking unit 64 can be switched between a locking position and an unlocking position. The second key-operable locking unit 66 can be switched between a locking and an unlocking position regardless of the first combination locking unit 64. More details of the first and second key-operable locking units 64 and 66 will not be given for briefness.

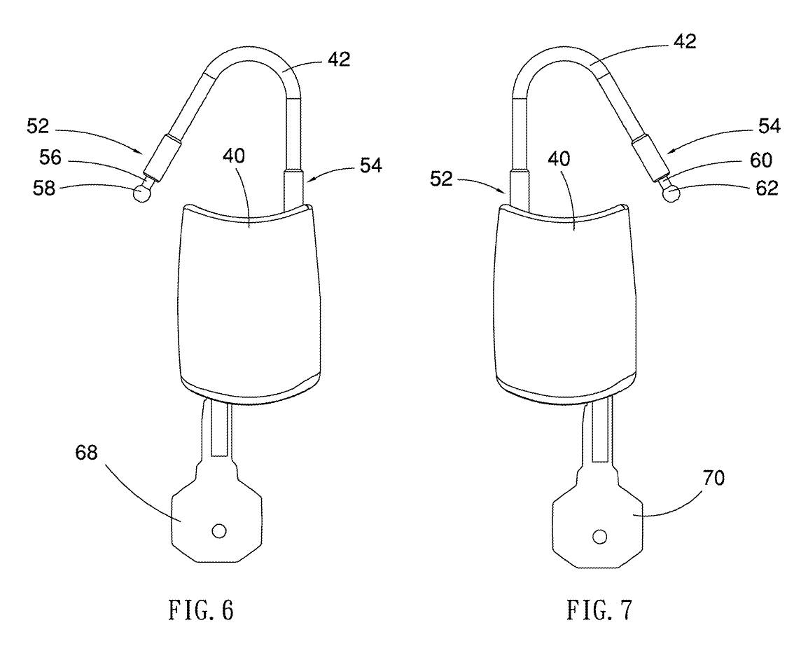

Referring to FIGS. 5 and 6, a first key 68 is inserted and turned in the first key-operable locking unit 64 so that the first key-operable locking unit 64 is switched to the unlocking position from the locking position. Thus, the first insert 52 can be removed from the first lock hole 48. Therefore, the shackle 42 is unlocked.

Referring to FIGS. 5 and 7, a second key 70 is inserted and turned in the first key-operable locking unit 66 so that the second key-operable locking unit 66 is switched to the unlocking position from the locking position. Thus, the second insert 54 can be removed from the second lock hole 50. Hence, the shackle 42 is unlocked.

The first key 68 is held by a user of the padlock. The second key 70 is handed to the customs workers.

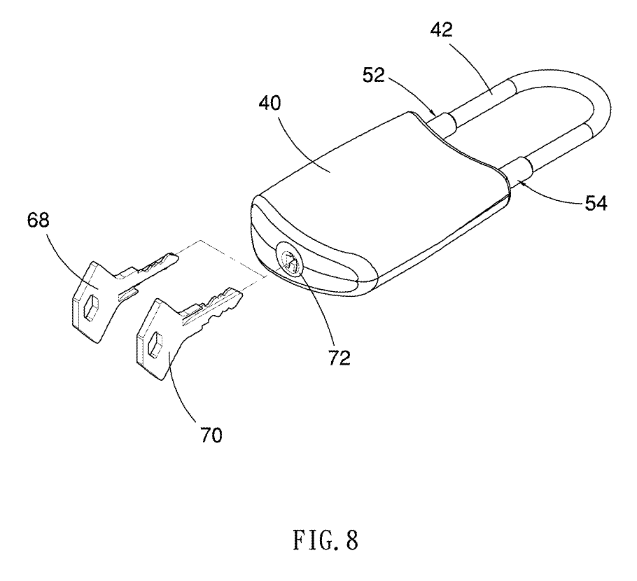

Referring to FIGS. 8 through 12, there is shown a padlock according to a third embodiment of the present invention. The third embodiment is similar to the second embodiment except including a single key-operable locking unit 72 instead of the first and second key-operable locking units 64 and 66 of the second embodiment. The key-operable locking unit 72 is similar to the key-operable locking unit shown and described in U.S. patent application Ser. No. 11/603,029. The key-operable locking unit 72 can be used by with the first and second keys 68 and 70. That is, either the first key 68 or the second key 70 can be used to turn the key-operable locking unit 72 between a locking position and an unlocking position. More details of the key-operable locking unit 72 will not be given for briefness.

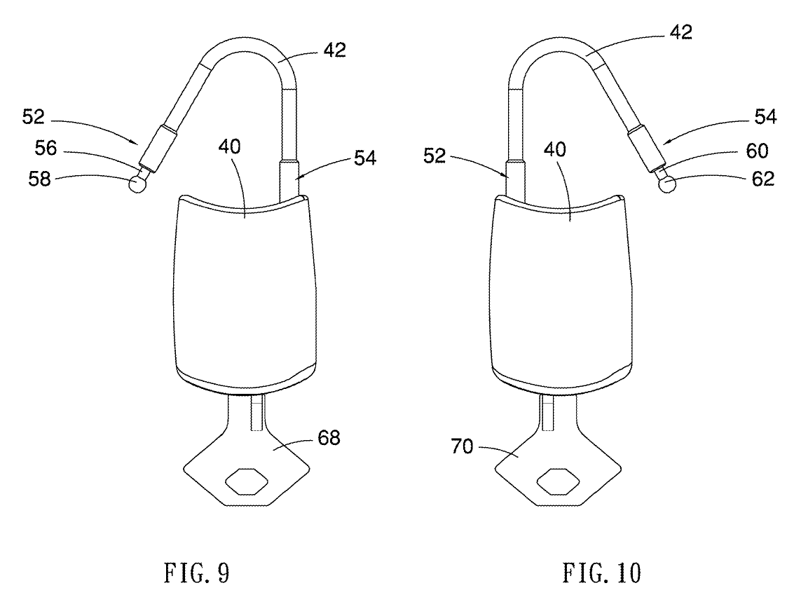

Referring to FIG. 9, the first key 68 is inserted and turned in the key-operable locking unit 72 so that the key-operable locking unit 72 is switched to the unlocking position from the locking position. Thus, the first insert 52 can be removed from the first lock hole 48. Therefore, the shackle 42 is unlocked.

Referring to FIG. 10, the second key 70 is inserted and turned in the key-operable locking unit 72 so that the key-operable locking unit 72 is switched to the unlocking position from the locking position. Thus, the second insert 54 can be removed from the second lock hole 50. Hence, the shackle 42 is unlocked.

The first key 68 is held by a user of the padlock. The second key 70 is handed to the customs workers.

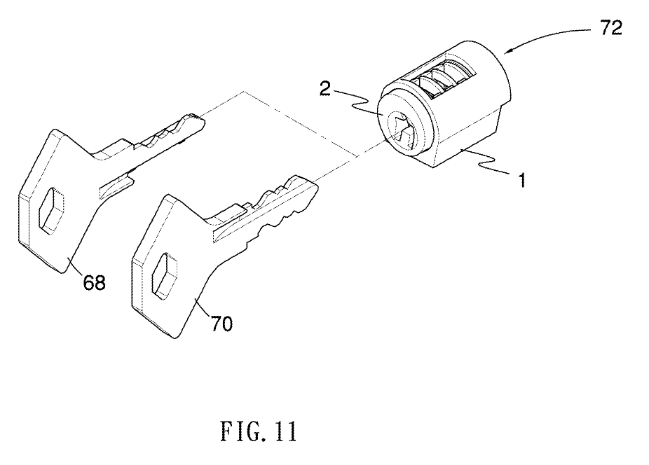

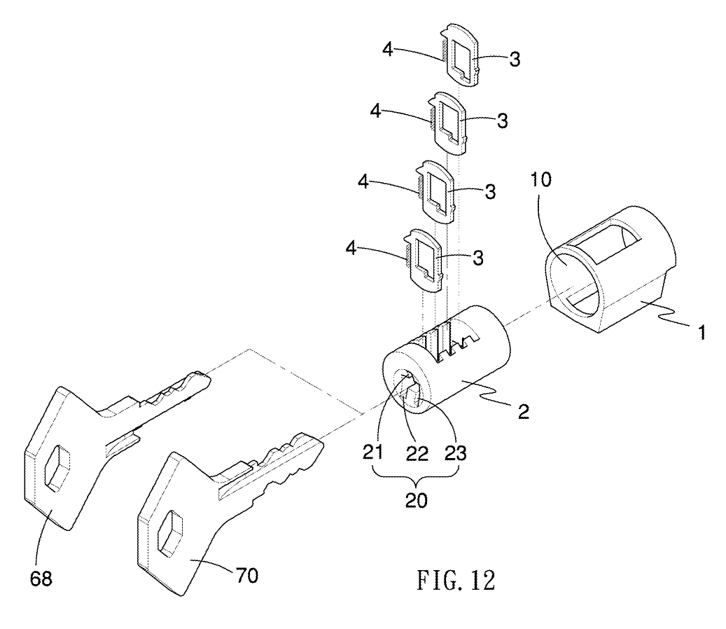

In FIGS. 11 and 12, the key-operable locking unit 72 includes a lock core which comprises a cylinder 1, a shaft 2, a plurality of driving members 3 and a plurality of springs 4. As shown in FIG. 12, the cylinder 1 defines a chamber 10 for receiving the shaft 2, and the shaft 2 defines a keyhole 20 comprising a first slot 21, a second slot 22 in communication with the first slot 21, and a third slot 23 in communication with the first slot 21. Furthermore, the first and second slots 21, 22 receive the first key 68, and the first and third slots 21, 23 receive the second key 70. More details of the key-operable locking unit 72 will not be given for briefness as described in U.S. patent application Ser. No. 11/603,029.

The present invention includes been described by the detailed illustration of the preferred embodiment. Those skilled in the art can derive variations from the preferred embodiment without departing from the scope of the present invention. Therefore, the preferred embodiment shall not limit the scope of the present invention defined in the claims.

1. A padlock comprising:
a lock body comprising a first lock hole defined therein and a second lock hole defined therein;
a shackle comprising a first end for insertion in the first lock hole and a second end for insertion in the second lock hole; and
at least one locking unit changeable in the lock body between a locking position for locking the first and second ends of the shackle in the first and second lock holes, a first unlocking position for allowing the first end of the shackle to be removed from the first lock hole and a second unlocking position for allowing the second end of the shackle to be removed from the second lock hole.

2. The padlock according to claim 1, wherein the locking unit comprises:
a first locking unit switchable in the lock body for locking the first end of the shackle in the first lock hole and for allowing the first end of the shackle to be removed from the first lock hole; and
a second locking unit switchable in the lock body for locking the second end of the shackle in the second lock hole and for allowing the second end of the shackle to be removed from the second lock hole.

3. The padlock according to claim 2, wherein the lock body comprising a first compartment defined therein for containing the first locking unit and a second compartment defined therein for containing the second locking unit.

4. The padlock according to claim 2, wherein the first locking unit is selected from the group consisting of a key-operable locking unit and a combination locking unit.

5. The padlock according to claim 2, wherein the second locking unit is selected from the group consisting of a key-operable locking unit and a combination locking unit.

6. The padlock according to claim 2, wherein the first and second locking units are identical.

7. The padlock according to claim 2, wherein the first and second locking units are different.

8. The padlock according to claim 2, wherein the shackle comprises a first insert formed at the first end thereof for insertion into the first locking unit and a second insert formed at the second end thereof for insertion into the second locking unit.

9. The padlock according to claim 8, wherein each of the first and second inserts comprises a neck and a head formed on the neck, and the diameter of the neck is smaller than that of the head.

10. The padlock according to claim 9, wherein each of the first and second lock holes comprises an aperture and a slot in communication with the aperture, the diameter of the aperture is larger than the width of the slot so that the head can be inserted through the aperture so that the neck can be moved into the slot, and the neck is locked in the slot by a related one of the first and second locking units in the locking position.

11. The padlock according to claim 10 comprising a first restraining block for restraining the head of the first insert and therefore retaining the neck of the first insert in the slot of the first lock hole under the control of the first locking unit.

12. The padlock according to claim 11, wherein the first restraining block is a swinging restraining block comprising a longitudinal slot defined therein, and the lock body comprises a post inserted into the longitudinal slot so that the swinging restraining block is movable clockwise, counterclockwise, upwards and downwards relative to the post.

13. The padlock according to claim 12, wherein the first locking unit is a combination locking unit comprising a numeral wheel set and a driving rod operatively connected to the numeral wheel set and formed with an end for engagement with an edge of the swinging restraining block.

14. The padlock according to claim 11 comprising a second restraining block for restraining the head of the second insert and therefore retaining the neck of the second insert in the slot of the second lock hole under the control of the second locking unit.

15. The padlock according to claim 14, wherein the second restraining block is a rotary restraining block located at an end of the second locking unit.

16. The padlock according to claim 1, wherein the locking unit is a key-operable locking unit operable by two different keys.

17. The padlock according to claim 16, wherein the locking unit comprises a lock core comprising:
a cylinder defining a chamber; and
a shaft rotatably received in the chamber and defining a keyhole which comprises a first slot, a second slot in communication with the first slot, and a third slot in communication with the first slot, wherein the first and second slots receive a first key, and the first and third slots receive a second key.

18. The padlock according to claim 17, the lock core comprising a plurality of driving members disposed between the shaft and the cylinder, and either the first key or the second key can be inserted in the keyhole for controlling the driving members to rotate the shaft.

19. The padlock according to claim 18, the lock core comprising a plurality of springs, the cylinder comprising a wall defining an opening in communication with the chamber, the shaft defining a plurality of channels for receiving the driving members and a plurality of rooms in communication with the channels, the springs being installed in the rooms for pushing the driving members so that each of the driving members comprises an end embedded in the opening of the cylinder.

20. The padlock according to claim 19, wherein each of the driving members defines an aperture with a wall that comprises a first face and a second face, and the first and second faces can be driven by the first and second keys respectively so that the end of each of the driving members is retracted into the shaft.
